(19) United States
(12) Patent Application Publication
(10) Pub. No.: US 2019/0155237 A1
(43) Pub. Date: May 23, 2019

(54) REMOTE CONTROL OF MULTIPLE DIFFERENT MACHINES

(71) Applicant: Deere & Company, Moline, IL (US)

(72) Inventors: Michael G. Kean, Maquoketa, IA (US); Giovanni A. Wuisan, Epworth, IA (US); Leah B. Leffler, Moline, IL (US); William W. Staidl, Hazel Green, WI (US)

(21) Appl. No.: 15/819,589

(22) Filed: Nov. 21, 2017

(51) Int. Cl. G05B 19/042

(52) U.S. Cl. CPC G05B 19/0423; G05B 2219/25032; G05B 2219/21102

(57) ABSTRACT

A control hub receives machine operation requests from multiple different machines that are located remotely from the control hub. The control hub selects a remote operator to service each of the machine requests, from a remote operator station. The control hub then facilitates communication between the machines requesting operation, and the operators selected to service those requests, from their remote operator station.

### FIELD OF THE DESCRIPTION

The present description relates to a system for remotely controlling machines. More specifically, the present description relates to receiving machine requests from multiple different machines and remotely controlling multiple different machines, based upon the requests.

### BACKGROUND

There are many different types of mobile machines, including construction equipment, agricultural equipment, forestry equipment, turf management equipment, among others. These types of machines are often deployed at various different types of worksites.

By way of example, construction worksites may include worksites where material is being moved around the worksite or to and from the worksite, relatively continuously. In addition, a worksite may include a quarry where a wheel loader is deployed. The wheel loader may be needed only intermittently in order to fill dump trucks as they arrive at the quarry.

These types of mobile machines are often large, relatively expensive, and quite complex to operate. Thus, it can be difficult to find skilled operators to operate the machines.

In addition, these types of machines can often be operated in different modes. In a manual operation mode, an operator is located in the operator compartment of the machine. In an autonomous mode, the machine operates autonomously, with little or no operator interaction. In a semi-autonomous mode, the machine may operate autonomously at times, or to perform certain operations, but then be operated manually, or remotely by a remote operator, at other times, or to perform other types of operations.

The discussion above is merely provided for general background information and is not intended to be used as an aid in determining the scope of the claimed subject matter.

### SUMMARY

A control hub receives machine operation requests from multiple different machines that are located remotely from the control hub. The control hub selects a remote operator to service each of the machine requests, from a remote operator station. The control hub then facilitates communication between the machines requesting operation, and the operators selected to service those requests, from their remote operator station.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is block diagram of one example of a remote control operation architecture.

FIG. 2 is a block diagram showing one example of portions of a machine in more detail.

FIG. 3 illustrates a block diagram showing the architecture illustrated in FIG. 1, with parts of the architecture shown in more detail.

FIGS. 4A-4B (collectively referred to herein as FIG. 4) illustrate a flow diagram showing one example of the operation of a control hub computing system in more detail.

FIGS. 5A and 5B (collectively referred to herein as FIG. 5) illustrate a flow diagram showing one example of the operation of an operator station in more detail.

FIG. 6 is a flow diagram showing one example of the operation of a machine computing system in more detail.

FIG. 7 is a block diagram showing one example of the architecture illustrated in FIGS. 1 and 2, deployed in a remote server architecture.

FIGS. 8-10 show examples of mobile devices that can be used in the architectures shown in the previous figures.

FIG. 11 is a block diagram showing one example of a computing environment that can be used in the architectures shown in the previous figures.

### DETAILED DESCRIPTION

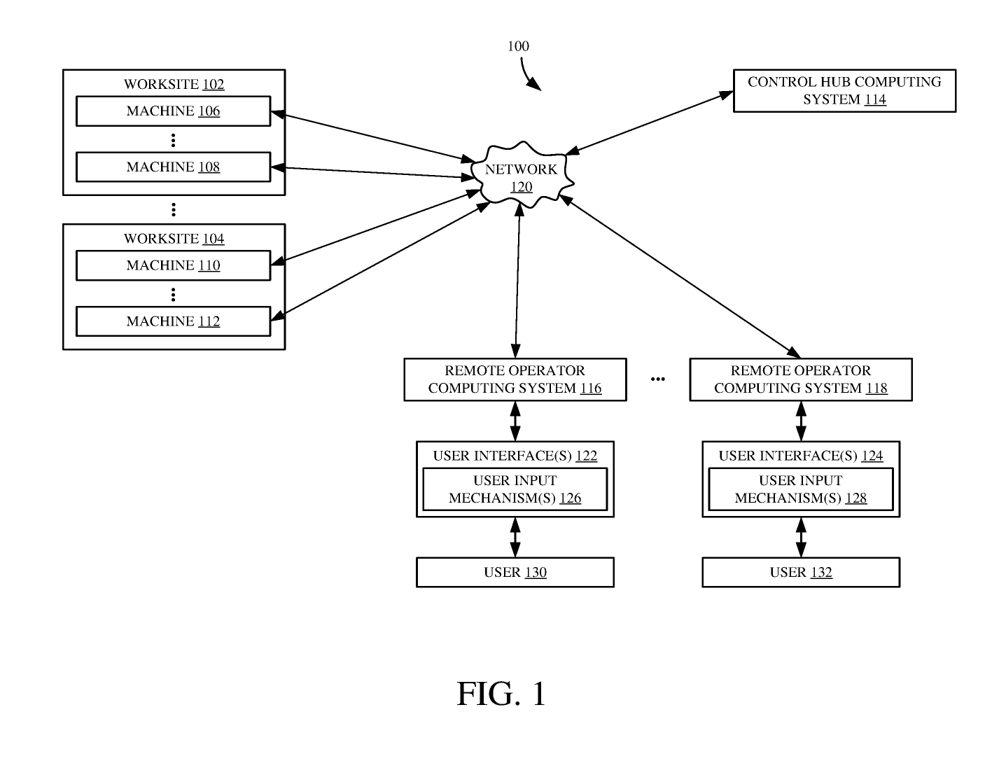

FIG. 1 is a block diagram showing one example of a remote control operation architecture 100. Architecture 100 shows a plurality of different worksites 102-104, each of which may have a plurality of different machines 106-108 and 110-112, respectively. The machines illustratively perform worksite operations at their corresponding worksites.

In the example shown in FIG. 1, the machines at worksites 102-104 are illustratively connected to control hub computing system 114, and can be connected to any of a variety of different remote operator computing systems 116-118, through network 120. Network 120 can be a wide area network, a local area network, a cellular communication network, a near field communication network, or a wide variety of other networks or combinations of networks.

Each of the remote operator computing systems 116-118, illustrated in FIG. 1, is shown generating one or more user interfaces 122-124, with user input mechanisms 126-128 for interaction by different operators 130-132. Operators 130-132 illustratively interact with user input mechanisms 126-128 in order to control and manipulate remote operator computing systems 116-118 and ultimately to control the operation of one or more machines 106-112.

In the example illustrated in FIG. 1, machines 106-112 are illustratively machines that are configured so that they can be remotely operated. They can send requests for remote operation to control hub computing system 114. Based on the requested operation, based on the type of machine, or based on any of a wide variety of other filter criteria, control hub computing system 114 illustratively identifies a particular operator 130-132 that will be selected to perform the remote control operation requested by the requesting machine. Control hub computing system 114 then illustratively facilitates remote control communication between the selected operator and the requesting machine.

For instance, assume machine 106 requests a remote control operation. Control hub computing system 114 can receive that request and apply a variety of different filter criteria to select a particular operator to perform the remote control operation. Assume further that control hub computing system 114 selects operator 130 to perform the remote control operation. It thus notifies operator 130 of this, and establishes a communication link between operator 130 and machine 106. The communication link will illustratively be a relatively low latency, secure communication link that uses an encryption protocol, although this is only an example. Machine 106 can provide a variety of different types of data for review by operator 130. The data can include the dashboard data, data from any onboard cameras or other sensors, data from related sensors that may be deployed at worksite 102, or a wide variety of other data. Operator 130 illustratively provides user inputs through user input mechanisms 126 that are mapped to the control functions on machine 106. Thus, as user 130 provides inputs through user input mechanisms 126, a control system on machine 106 receives signals indicative of those user inputs and performs control operations to control machine 106 based upon the user inputs. Machine 106 also illustratively provides feedback to update the data sent to operator 130. For instance, it can update any video or image data, any sensor data, the dashboard data, etc., as operator 130 continues to perform the remote control operation.

Architecture 100 is thus useful in a wide variety of different scenarios. For instance, assume that machine 106 is a loader that is deployed in a quarry and that is used to load dump trucks that arrive at the quarry. Assume further that loader 106 need only be operated for relatively short intervals of time, intermittently throughout the day. The present architecture illustratively allows the machine to be operated, as needed, without deploying a full time operator for machine 106. Instead, operator 130 may be used to operate multiple different machines 106-112, throughout a given day. Further, control hub computing system 114 can apply a wide variety of different types of filter criteria in selecting an operator to control a machine. The filter criteria can include such things as the type of operation, the duration of operation, the type of machine being operated, the certification level or credentials of the operator, the cost of the operator, etc. Rules or other mechanisms can be defined in control hub computing system 114 so that the filter criteria applied in selecting an operator can be configurable and scalable. Thus, an organization or an individual can configure the rules to select a highly skilled operator where the machine or the type of operation may benefit from such a high skill level. However, where the machine or type of operation can be performed by a relatively low skilled operator, then the filter criteria illustratively surface a different operator, which may have less skill, fewer credentials, fewer certifications, etc.

The present description may also illustratively enhance the safety of a worksite 102-104. For instance, it may be that the machines 106-112 are semi-autonomous machines where they are performing operations automatically based on an autonomous control algorithm. However, they may get into situations where the autonomous control algorithm is configured to request manual intervention. At that point, the particular machine may send a remote control operation request to control hub computing system 114 which selects an operator 130-132 to perform remote control operation until autonomous operation can again be resumed.

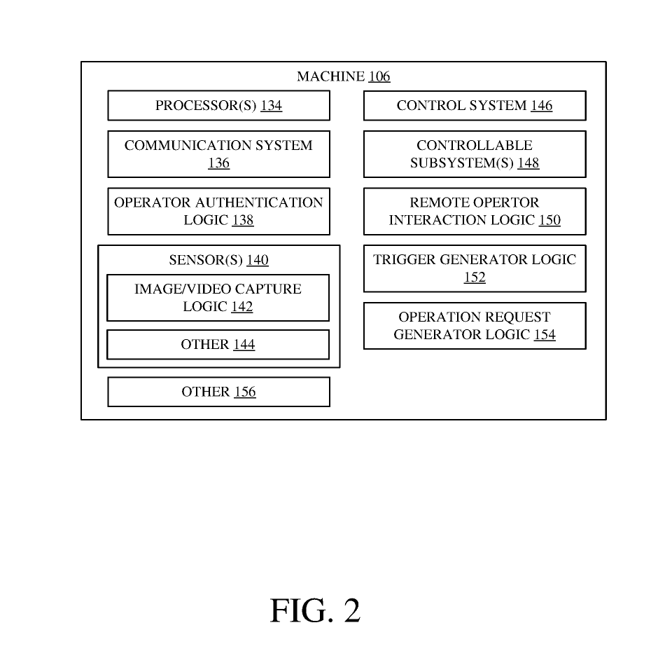

FIG. 2 is a block diagram showing one example of a machine (in this case, machine 106) in more detail. In the example shown in FIG. 2, machine 106 illustratively includes one or more processors 134, one or more communication systems 136, operator authentication logic 138, a plurality of different sensors 140 (which can include image/video capture logic 142, and a wide variety of other sensors 144), a control system 146 that controls a variety of different controllable subsystems 148, remote operator interaction logic 150, trigger generator logic 152, operation request generator logic 154, and it can include a wide variety of other items 156. Before describing the operation of machine 106 and architecture 100 in more detail, a brief overview of some of the items in machine 106, and their operation will first be provided.

Communication system 136 is a system that illustratively communicates over network 120 with control hub computing system 114 and with one or more remote operator computing system 116-118. Therefore, it can include a communication system that enables communication over a wide area network, a cellular communication network, a near field communication network, a local area network, and/or a wide variety of other networks or combinations of networks. In one example, it illustratively enables communication using a security protocol so that information sent and received over the communication network can be encrypted and decrypted to enhance security.

Operator authentication logic 138 is illustratively an authentication system (which may be local to machine 106 or which may be remote from machine 106 and accessed by machine 106) that is used to authenticate a remote operator that is seeking to perform remote control operation of machine 106. The authentication mechanism can be any of a wide variety of different types of authentication mechanisms, such as a username and password type of authentication mechanism, a smart card authentication mechanism, a biometric authentication mechanism, among others.

Sensors 140 can include a wide variety of different types of sensors including the image and video capture logic 142 that can be used to capture video information as well as image information from one or more cameras deployed on machine 106 or from one or more cameras in worksite 102 that are trained to capture information in the vicinity of machine 106, or elsewhere. Sensors 144 can also include a wide variety of different types of machine sensors that may provide sensor signals over a controller area network (CAN) bus, or they can include external sensors, that are not carried by machine 106 but that are instead deployed at worksite 102 to sense other items. For instance, a sensor may be deployed to sense when a dump truck enters a quarry or other worksite. This may serve as a trigger to send a remote control operation request to control hub computing system 114. These and other scenarios are described in greater detail below.

Trigger generator logic 152 illustratively detects a trigger indicating that a remote control operation request should be sent from machine 106 to control hub computing system 114. Again, the triggers can be generated based on a wide variety of different sensor inputs. They can be generated periodically (such as when the machine is scheduled to operate at predefined times). They can be generated in other ways as well. Once a trigger is detected and generated, operation request generator logic 154 illustratively prepares an operation request that can be sent by communication system 136 to control hub computing system 114 requesting a remote control operation to be performed with respect to machine 106. Control hub computing system 114, in response, selects an operator to perform that remote control operation and can establish a communication link between the remote operator computing system and communication system 136 on machine 106. Remote operator interaction logic 150 illustratively receives the remote operator's control inputs and provides them to control system 146 which controls a variety of different controllable subsystems 148 based on those inputs. The controllable subsystems 148 can include a wide variety of different types of controllable subsystems, depending on the type of machine 106. For instance, they can include a propulsion system, a steering system, a variety of different actuators that can perform operations such as digging and dumping, and a wide variety of other operations.

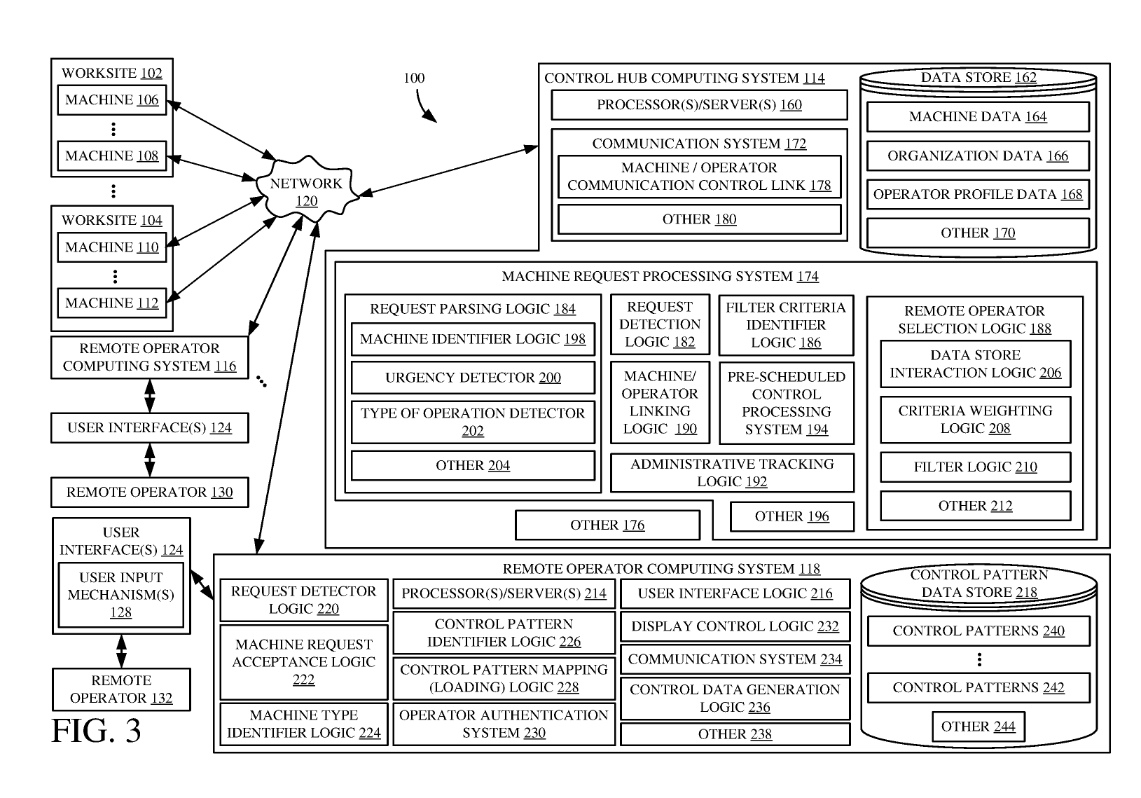

FIG. 3 illustrates a block diagram showing one example of architecture 100, with control hub computing system 114 and remote operator computing system 118 shown in more detail. In the example shown in FIG. 3, control hub computing system 114 illustratively includes one or more processors or servers 160, data store 162 (which illustratively stores machine data 164, organization data 166, operator profile/availability data 168, and which can store a wide variety of other data 170), communication system 172, machine request processing system 174, and it can include a wide variety of other items 176. In the example shown in FIG. 3, communication system 170 illustratively includes machine/operator communication control link 178, and it can include other items 180. Also, in the example shown in FIG. 3, machine request processing system 174 can include request detection logic 182, request parsing logic 184, filter criteria identifier logic 186, remote operator selection logic 188, machine/operator linking logic 190, administrative tracking logic 192, pre-scheduled control processing system 194, and it can include a wide variety of other items 196. In the example shown in FIG. 3, request parsing logic 184 can include machine identifier logic 198, urgency detector 200, type of operation detector 202, and it can include other items 204. Remote operator selection logic 188 can also include data store interaction logic 206, criteria weighting logic 208, filter logic 210, and it can include other items 212.

Also, in the example shown in FIG. 3, remote operator computing system 118 can, itself, include one or more processors or servers 214, user interface logic 216, control pattern data store 218, request detector logic 220, machine request acceptance logic 222, machine type identifying logic 224, control pattern identifier logic 226, control pattern mapping (loading) logic 228, operator authentication system 230, display control logic 232, communication system 234, control data configuration logic 236, and it can include other items 238. Control pattern data store 218 illustratively includes a plurality of different control patterns 240-242 that correspond to different types of machines 106-112. Control patterns 240-242 illustratively map user inputs on various different user input mechanisms 128 to control operations that control the particular machine corresponding to the control patterns 240-242. Control pattern data store 218 can include other items 244 as well.

Again, before describing the overall operation of architecture 100 in more detail, a brief description of some of the items in control hub computing system 114 and remote operator computing system 118, and their operation, will first be provided.

Communication system 172 illustratively allows control hub computing system 114 to communicate with machines 106-112 and with remote operator computing systems 116-118. It can also include machine/operator control link 178. Therefore, once an operator is selected to perform a remote control operation on a machine, the control communications from that operator to the machine, and the feedback communications, can be provided through control hub computing system 114, and specifically through machine/operator communication control link 178. In another example, machine/operator communication control link 178 can facilitate a link between the remote operator computing system for the selected remote control operator and the requesting machine. For instance, it can provide the addresses or other identifying information to the remote operator interaction logic 150 on the machine, and to the communication system 234 on the remote operator computing system 118. It can facilitate secure control communications between the selected operator and the requesting machine in other ways as well.

Machine data 164 in data store 162 can include a wide variety of different types of data corresponding to the different machines 106-112. For instance, the requesting machine 106 may provide a machine identifier which can be used to access machine data 164 for that particular machine. The machine data 164 may include such things as the type of machine, the different systems on the machine, etc.

Organization data 166 may be used to define various preferences or filter criteria that may be used by different organizations, such as the organizations that own machines 106-112, or other organizations. The organization data 166 can thus include operator preferences, cost limits, desired certifications or credentials for a selected operator, etc.

Operator profile/availability data 168 illustratively identifies information corresponding to each of the operators 130-132 that can be selected. The information can include the certifications and experience of an operator, other qualifications corresponding to an operator, the availability (such as dates, days, times, etc.) that the operator is available to perform remote control operations, the cost that will be charged by the operator, among a wide variety of other things.

Machine request processing system 174 illustratively detects a request from a machine 106-112 for remote control operation. It then parses the request to identify various characteristics of the request so that an operator can be selected to perform the operation. Request detection logic 182 detects an operator request from a particular machine (such as machine 106). Request parsing logic 184 parses the request to identify different information that can be used to select an operator. For instance, machine identifier logic 198 illustratively identifies the particular machine making the request and can access machine data 164 corresponding to that machine. Urgency detector 200 detects an urgency corresponding to the request. For instance, if the machine is stuck, or there are safety considerations corresponding to the request, then the urgency may be high. The urgency may be high or low (or different level) for a wide variety of other reasons as well. The urgency level is detected by detector 200 and can be used to select an operator. For instance, certain operators may be preferred for highly urgent operations, etc. Type of operation detector 202 illustratively detects the type of remote control operation that is being requested. If the type of operation is of high complexity and requires a highly skilled operator, then this may be used as filter criteria for selecting an operator. In addition, it may be that organization data 166 specifies that certain types of operators are preferred to perform certain types of requested operations. Thus, the type of operation can be used to select an operator in this way as well.

Filter criteria identifier logic 186 illustratively identifies the various filter criteria that can be used to select an operator. The filter criteria can be identified in the request itself, in the machine data 164, organization data 166, operator profile/availability data 168, or from other sources.

Remote operator selection logic 188 then selects a particular operator, or a set of operators that may be used to perform the requested remote control operation. It can do so by using data store interaction logic 206 to filter the operator profile/availability data 168 based upon the various filter criteria that were identified by logic 186. It can use criteria weighting logic 208 to weight the criteria using various weighting mechanisms. For instance, it may be that organization data 166 specifies which types of filter criteria are more important for that organization. It may be that the operator profile/availability data 168 specifies the types of criteria that the operator believes are more important in identifying that operator as the selected operator. Filter logic 210 then applies the weighted filter criteria to the operator profile/availability data 168 to identify a particular operator 130-132 that will be selected to perform the remote control operation.

Machine/operator linking logic 190 illustratively establishes or facilitates a secure link between the selected operator (e.g., remote operator 132) and the requesting machine (e.g., machine 106). Again, the communication can go through control hub computing system 114, or logic 190 can simply facilitate that communication using another communication channel.

Administrative tracking logic 192 can be used to track a wide variety of different types of administrative parameters. For instance, it can track the amount of time that any given operator takes to perform any given remote control operation. It can track the number of operations performed by different operators. It can track costs charged or accumulated by different operators. It can detect how often (and the duration) that a particular machine makes requests (and is remotely operated), and it can track a wide variety of other administrative items as well.

It may also be that a particular machine 106 may schedule operations to be performed by a remote control operator at predefined times. In that case, pre-scheduled control processing system 194 tracks the pre-scheduled control operations and automatically triggers remote operator selection logic 188 to select a remote control operator for the pre-scheduled operation. It can do this by maintaining a schedule and providing an interface through which pre-scheduled operations can be entered on the schedule. It can do this in a wide variety of other ways as well.

On remote operator computing system 118, operator authentication system 230 illustratively allows remote operator 132 to authenticate himself or herself to remote operator computing system 118. It can also be used to interact with the authentication system on machine 106 to authenticate the operator to that machine, so that only an operator who is permitted to operate the machine 106, may perform the remote control operation.

User interface logic 216 illustratively detects user interactions with user input mechanisms 128. It can provide an indication of those interactions to other items on system 118 or elsewhere. Display control logic 232 illustratively generates and controls a user interface display, such as the display of the dashboard information, the camera and other image information from a machine 106, the sensor information from a machine 106 or a worksite 102, etc.

Request detector logic 220 detects when machine request processing system 174 sends a remote control operation request to remote operator computing system 118. Machine request acceptance logic 222 illustratively surfaces a user interface for remote operator 132, with a user input mechanism 128 that allows remote operator 132 to accept or decline the request to perform the remote control operation. Machine request acceptance logic 222 may include information describing the machine, the organization that owns the machine, the type of operation to be performed, the urgency level, etc. If the remote operator 132 accepts the request, then machine type identifying logic 224 identifies the type of machine making the request and provides it to control pattern identifier logic 226. Control pattern identifier logic 226 accesses control pattern data store 218 and identifies a particular control algorithm or control pattern 240-242 that corresponds to the type of machine making the request. A selected control pattern 240 maps the user inputs from various user input devices on the remote operator computing system 118 to the control commands that are used to control the requesting machine 106. For instance, it may be that, with one machine, a joystick operates the propulsion and steering system on machine 106. For another machine, the joystick may operate the dig and dump actuators. These are examples only.

Once the control pattern 240 corresponding to the requesting machine 106 is identified, control pattern mapping (loading) logic 228 loads that control pattern. Control data generation logic 236 can then generate control data that can be sent through communication system 234, and over the secure communication control link, to machine 106 in order to remotely operate machine 106, based on the operator inputs.

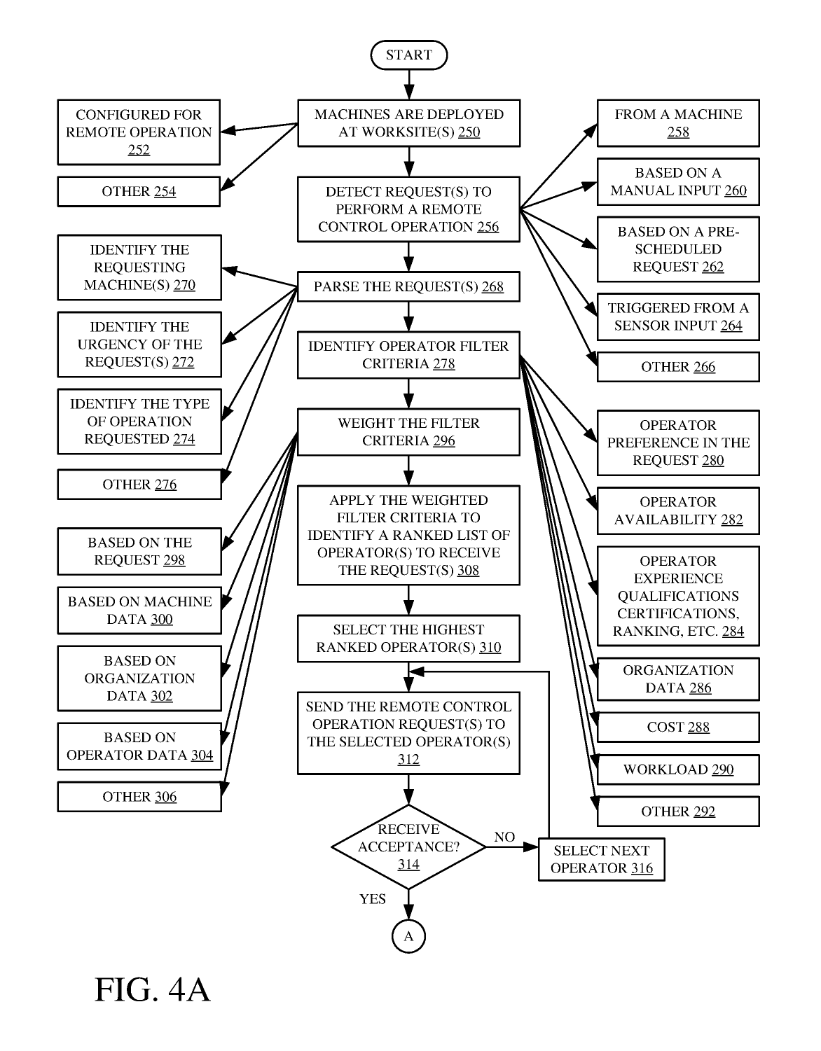

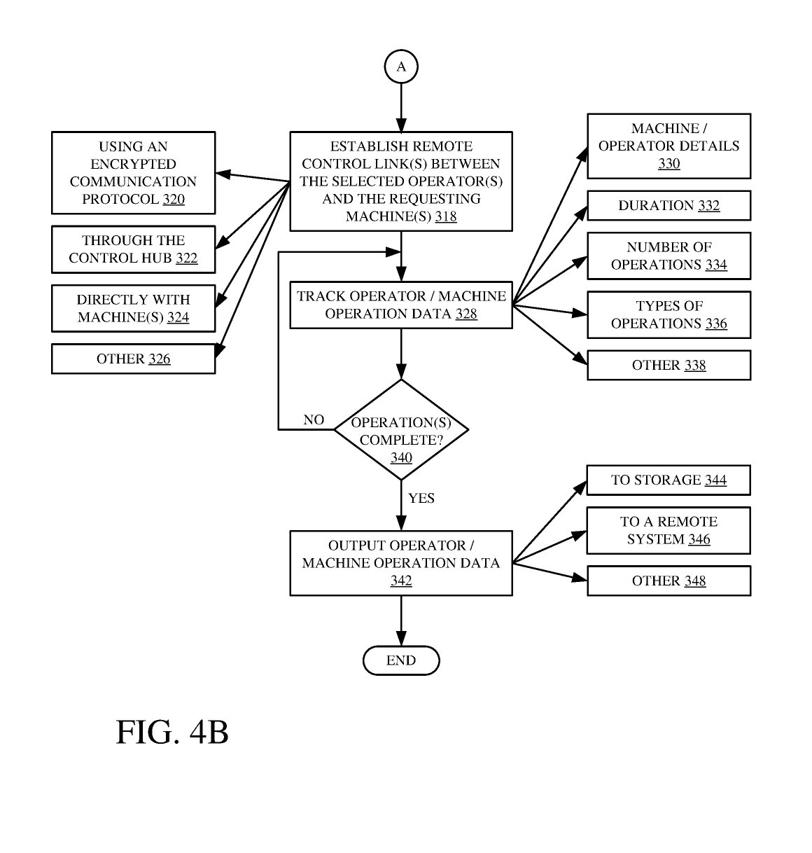

FIGS. 4A and 4B (collectively referred to herein as FIG. 4) illustrate a flow diagram showing one example of the operation of architecture 100, from the perspective of control hub computing system 114. It is first assumed that a plurality of different machines 106-112 are deployed at one or more different worksites 102-104. This is indicated by block 250 in the flow diagram of FIG. 4. The machines are illustratively configured to be controlled remotely. This is indicated by block 252. They can be configured in other ways as well, and this is indicated by block 254.

Request detection logic 182 then detects a request from a machine (e.g., machine 106) to perform a remote control operation. This is indicated by block 256 in the flow diagram of FIG. 4. The request can be received from a machine 106 as indicated by block 258. It can also be based on a manual input. For instance, it may be that a dump truck operator arrives at a quarry where machine 106 is deployed. The dump truck operator may then, for example, scan a QR code on the side of the machine, with his or her mobile device. The QR code can be sent to control hub computing system 104 and detected by request detection logic 182 as a request for remote control operation of the machine 106. Detecting the request based on a manual input is indicated by block 260.

The request can be detected based on pre-scheduled control processing system 194 determining that a pre-scheduled operation is to be performed. This is indicated by block 262. The request can be detected based on a sensor input as well. For instance, it may be that a dump truck arrives at a quarry, and the dump truck's arrival is detected by a motion sensor, or another sensor, at the quarry location. That sensor can provide an input indicating that the dump truck has been sensed, to control hub computing system 114 where it can be detected by request detection logic 182 as a request for remote control operation of machine 106. Detecting a request for remote control operation that is triggered from a sensor input is indicated by block 264. The request to perform a remote control operation can be detected in a wide variety of other ways as well, and this is indicated by block 266.

Request parsing logic 184 then parses the request. This is indicated by block 268. By way of example, machine identifier logic 198 can identify the requesting machine 106. This is indicated by block 270. For instance, it may be that the request has a machine identifier identifying the machine for which remote control operation is requested. The machine can be identified in other ways as well.

Urgency detector 200 illustratively identifies an urgency of the request. This is indicated by block 272. Type of operation detector 202 identifies the type of operation requested as indicated by block 274. The request can be parsed to identify other information as well, and this is indicated by block 276.

Filter criteria identifier logic 186 then identifies operator filter criteria that may be used to select a particular operator to perform the requested operation. This is indicated by block 278. The operator filter criteria can be identified from the request itself. For instance, any of the information parsed out of the request may be used as filter criteria. The request may include an operator preference which specifies a preferred operator. This is indicated by block 280. The filter criteria may be based on operator profile/availability data, such as whether a particular operator is currently available to perform the operation, or whether the operator is unavailable due to the operator's schedule or due to the fact that the operator is servicing another request. Using operator availability as one of the filter criteria is indicated by block 282.

The filter criteria can also include the operator experience, qualifications, certifications or other credentials, an operator ranking that is based on feedback from various individuals, or other operator profile data or operator ranking data. This is indicated by block 284.

The filter criteria can be identified from the organization data 166, which may indicate the specific operators or the types of operators that are preferred to perform various operations, to perform operations of different urgency levels, to perform operations on different types of machines, etc. This is indicated by block 286. The filter criteria can include the cost to be charged by the operator as indicated by block 288, the workload of the operator (such as how many operations the operator has recently performed) as indicated by block 290, or a wide variety of other operator filter criteria, as indicated by block 292.

Criteria weighting logic 208 then weights the filter criteria. This is indicated by block 296. For instance, data store interaction logic 206 can interact with data store 162 to identify weighting information that may be used to weight the filter criteria. The weights can be based upon information in the request, as indicated by block 298. The weights for the filter criteria can be based on machine data as indicated by block 300. They can be based on organization data as indicated by block 302. They can be based on operator profile/availability data as indicated by block 304, and they can be based on other things, as indicated by block 306.

Filter logic 210 then applies the weighted filter criteria to identify a ranked list of operators that are to receive the request. For instance, it may be that the ranked list includes a set of operators, all of whom can perform the remote control operation, but they may be ranked in increasing order of cost. They may be ranked in decreasing order of operator credentials, or they may be ranked in a wide variety of other ways, such as based on organization preferences, operator preferences, etc. Applying the weighted filter criteria to identify a ranked list of operators to receive the request is indicated by block 308. The weighted filter criteria can be applied to the operator profile/availability data 168, or they can be applied to other data or in other ways to select an operator.

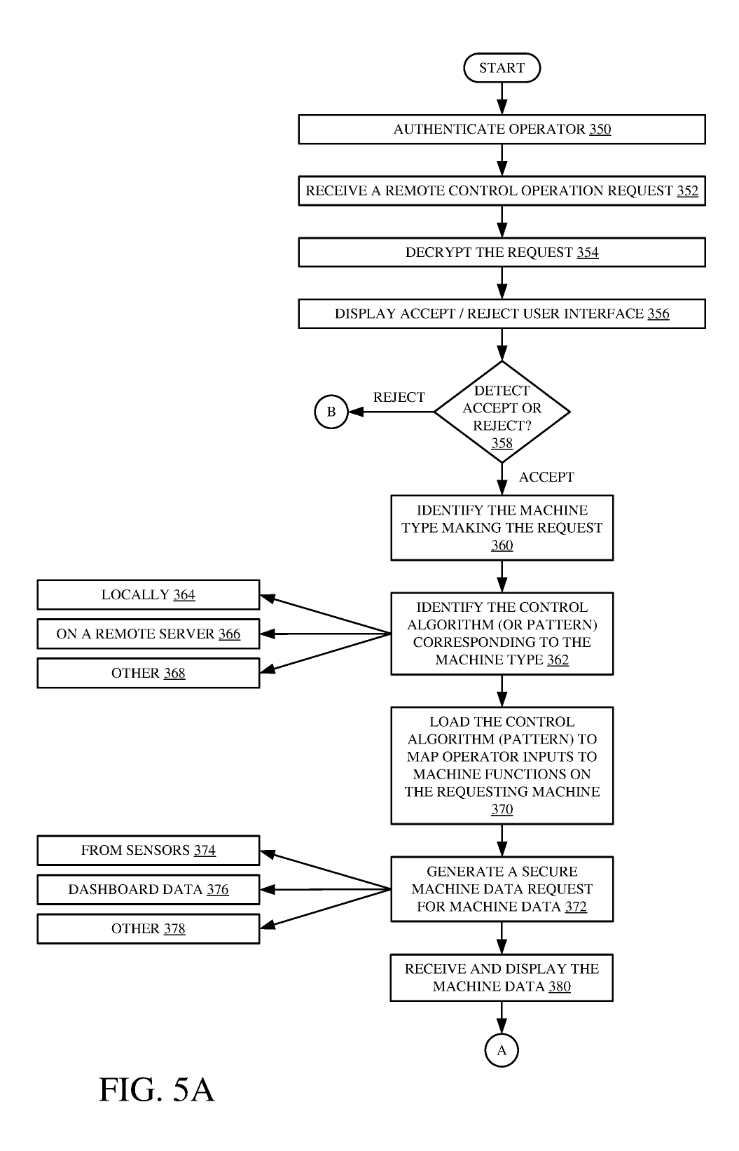

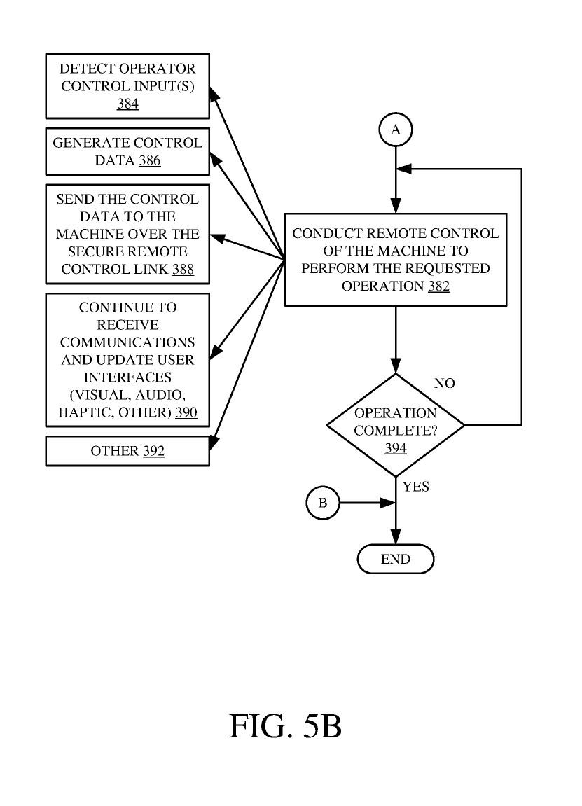

Machine/operator linking logic 190 then selects the top ranked operator from the list, as indicated by block 310, and sends the remote control operation request to the selected operator, as indicated by block 312. As is described below with respect to FIG. 5, the operator (e.g., remote operator 132) then has a chance to accept or reject the request to perform the remote control operation. The result of that decision is sent back to machine/operator linking logic 190. If the request is not accepted by the selected operator, as indicated by block 314, then the next operator on the ranked list is selected and the request is sent to that operator. This is indicated by block 316.

However, if, at block 314, the request is accepted by the operator, then machine/operating linking logic 190 can establish a remote control link between the selected operator and the requesting machine (e.g., between remote operator 132 and machine 106). This is indicated by block 318 in the flow diagram of FIG. 4. The remote control link is illustratively established so that it uses an encrypted communication protocol as indicated by block 320. It can be through the control hub computing system 114, as indicated by block 322, or it can be a communication link established directly between the remote operator computing system 118 of the selected remote operator 132 and the requesting machine 106. This is indicated by block 324. The link can be established in other ways as well, and this is indicated by block 326.

Administrative tracking logic 192 illustratively tracks the operator/machine operation data or various administrative characteristics of that data. This is indicated by block 328. For instance, it can track specific machine and operator data, such as the number of times that a particular operator has requested operation, the number of times that a particular operator has performed operations and the different types of operations, etc. This is indicated by block 330. It can track duration information indicative of how quickly an operator performed an operation, how quickly the operator accepted or rejected a request to perform an operation, among other things. This is indicated by block 332. It can detect the number of operations performed at a worksite 102, it can aggregate characteristics that are tracked for multiple different machines at multiple different worksites, or it can track the different numbers of operations in other ways as well. This is indicated by block 334. It can track the types of operations performed by the different types of operators, and using the different types of machines. This can be used to track the experience level of the different operators in performing different types of operations. Tracking the types of operations is indicated by block 336. Tracking characteristics of operator/machine operation can be done in a wide variety of other ways as well, and this is indicated by block 338.

Once the operation is complete, as indicated by block 340, then the tracked operator/machine data can be output to other systems. This is indicated by block 342. For instance, it can be output to a remote storage system as indicated by block 344. It can also be stored locally in data store 162. It can be output to a different remote system for analysis or for performing other operations. This is indicated by block 346. For instance, it may be output to a maintenance site which tracks the number of operations performed by a particular machine. It may then automatically identify, from a maintenance schedule, that a machine needs maintenance performed, and dispatch a maintenance person to perform maintenance on that machine. It can be output to a wide variety of other remote systems as well, and this is indicated by block 348.

It should also be noted that control hub computing system 114 can receive and process operation requests from various different machines in sequential order, or in parallel. Thus, it can receive operation requests from two different machines at substantially the same time, and select two different operators to perform those operations, based upon the characteristics of the requested operation, the machine to be operated, the urgency level, various preferences and operator information, etc.

FIGS. 5A and 5B (collectively referred to herein as FIG. 5), illustrate the operation of architecture 100, from the perspective of remote operator computing system 118. At some point, remote operator 132 illustratively logs into remote operator computing system 118 and is authenticated by operator authentication system 230. Authenticating the operator to remote operator computing system 118 is indicated by block 350 in the flow diagram of FIG. 5.

Request detector logic 220 then, at some point, detects that remote operator computing system 118 has received a request to perform a remote operation on a requesting machine (such as machine 106). The request is illustratively received from control hub computing system 114. Receiving a remote control operation request is indicated by block 352. Communication system 234 illustratively decrypts the request and machine request acceptance logic 222 illustratively generates a display (such as by using display control logic 232 or user interface logic 216, or both), that has a user input mechanism that can be actuated by remote operator 132 to either accept or reject the operation request. Decrypting the request is indicated by block 354 and displaying an accept/reject user interface display is indicated by block 356. Remote operator 132 can then interact with the accept/reject user interface in order to accept or reject the request to perform the remote control operation. User interaction with that interface can be detected by user interface logic 216. Determining whether the user accepts or rejects the request is indicated by block 358. If the user rejects the request, then remote operator computing system 118 performs no further processing with respect to the request, and control hub computing system 114 can select the next most highly ranked operator and send a request to that operator.

If, however, at block 358, it is determined that the remote operator 132 has accepted the request for remote control operation, then machine type identifier logic 224 illustratively identifies the type of the machine that is making the request. This is indicated by block 360. Based on the type of machine making the request, control pattern identifier logic 226 accesses control pattern data store 218 and identifies the particular control pattern 240-242 corresponding to the machine. This is indicated by block 362. Again, the control patterns 240-242 can be stored locally on remote operator computing system 118. This is indicated by block 364. They can be stored on a remote server as well (such as on control hub computing system 114 or in another remote location). This is indicated by block 366. The control algorithm or control pattern corresponding to the type of machine making the request can be identified in other ways as well, and this is indicated by block 368.

Control pattern mapping (or loading) logic 228 then loads the control pattern into remote operator computing system 118. This illustratively maps the operator inputs from various operator input devices at remote operator computing system 118 to machine functions on the requesting machine 106. Loading the control patterns is indicated by block 370 in the flow diagram of FIG. 5.

Display control logic 232 then generates a secure machine data request for machine data over the secure link that has been established by machine/operator linking logic 190 (if the data is not already sent to system 118). It can thus use communication system 234 to make the secure request. Generating a secure machine data request for machine data is indicated by block 372. The request for data can request machine 106 to send various information that can be displayed (or otherwise surfaced) to remote operator 132 and that remote operator 132 can use in performing the remote control operation. Thus, the data can be from sensors on machine 106 or sensors at worksite 102 or other sensors. This is indicated by block 374. The sensors can indicate a wide variety of different types of sensor data, and they can include video or image data, engine sensor data, pressures, speeds, soil conditions from soil condition sensors, or a wide variety of other sensor data. They can also include proximity data which indicates the proximity of machine 106 to other machines or obstacles, or other sensor data. The data sent by machine 106 can include dashboard data 376 that displays a variety of information that remote operator 132 may otherwise see on the dashboard of the machine 106 if remote operator 132 were operating machine 106 locally, in the operator compartment of machine 106. The secure data request can request a wide variety of other data as well, and this is indicated by block 378.

Display control logic 232 then receives and displays the machine data on a user interface device for remote operator 132. This is indicated by block 380. In addition to displaying the data, the data may be surfaced in other ways as well. For instance, if remote operator 132 is using a joystick to control a digging and dumping operation, the joystick may provide haptic feedback which indicates to the operator how full a bucket of an excavator or a loader is, for instance. Haptic feedback can be provided to indicate that the operator is approaching, or has contacted, an obstacle, or it can be provided in other ways as well. In addition, the data can be surfaced as audio information (including verbal synthesized or recorded speech, alerts, or other audio information), or it can be surfaced in other ways.

Control data generation logic 236 then conducts communication with machine 106 to perform remote control of the machine to complete the requested operation, based upon the inputs from remote operator 132. This is indicated by block 382 in the flow diagram of FIG. 5. For instance, logic 236 can use user interface logic 216 to detect operator control inputs using the various operator input mechanisms 128. This is indicated by block 384. It can generate control data based upon the control patterns loaded into system 118 which map the user inputs to various machine functions. Generating control data is indicated by block 386. It can use communication system 234 to send the control data to the machine 106 over the secure remote control link. This is indicated by block 388. It can continue to receive communications and update user interfaces (e.g., visual, audio, haptic, etc.) based upon information received from machine 106. This is indicated by block 390. Conducting the remote control of machine 106 to perform the requested operation can include a wide variety of other things as well, and this is indicated by block 392. The remote control operation can be conducted until the requested operation is complete, as indicated by block 394. At that point, control hub computing system 114 may disable or tear down the communication link between remote operator 132 and machine 106, or that link can be discontinued by remote operator 132, by remote operator computing system 118, or in other ways.

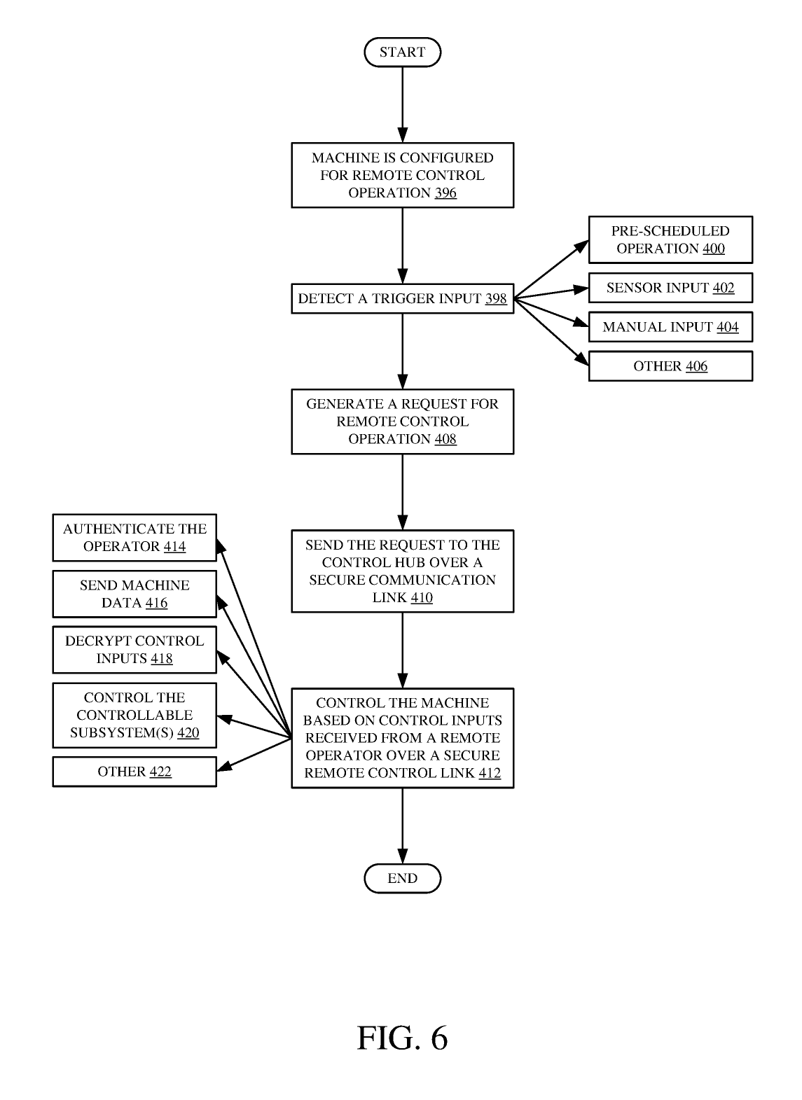

FIG. 6 is a flow diagram illustrating one example of the operation of architecture 100 from the standpoint of a requesting machine 106. It is first assumed, as discussed above, that machine 106 is configured for remote control operation. This is indicated by block 396 in the flow diagram of FIG. 6. At some point, trigger generator logic 152 generates a trigger indicating that a remote control operation for machine 106 should be requested from control hub computing system 114. This is indicated by block 398.

The trigger can be generated to indicate that the time for a pre-scheduled operation has arrived. This is indicated by block 400. The trigger can be generated based on a sensor input as indicated by block 402. For instance, it may be that the machine 106 is a semi-autonomously operated machine, but that it needs human intervention to perform some operations. A sensor may sense a scenario in which that type of operation is to be performed by machine 106. In another example, the sensor may be a sensor on the worksite 102 which senses that a dump truck has arrived and that machine 106 is to be operated in order to fill the dump truck. The sensor inputs can take a wide variety of other forms as well.

The trigger may be detected based on a manual input, as indicated by block 404. For instance, as discussed above, it may be that the operator of a dump truck who has arrived at a quarry scans a QR code in an area proximate machine 106. The QR code can generate a remote control operation request for machine 106 and it can be sent from the dump truck operator's mobile device to control hub computing system 114. The trigger can be generated and detected in a wide variety of other ways as well, and this is indicated by block 406.

Once the trigger is detected, operation request generator logic 154 generates a request for remote control operation. This is indicated by block 408. The request can include a wide variety of different types of information, such as the machine identifier for the requesting machine 106, the operation type, environmental conditions that are sensed by various sensors, machine data generated by sensors or systems on machine 106, or it can simply be a request to select an operator to perform an operation on machine 106, and the type of operation and other information can be sent in other communications.

Once the operation request has been generated by logic 154, remote operator interaction logic 150 uses communication system 136 to send the request to the control hub computing system 114 over a secure communication link. This is indicated by block 410. Once system 114 selects an operator and establishes communication between the remote operator 132 and the requesting machine 106, then remote operator interaction logic 150 receives the control inputs from remote operator 132 and provides them to control system 146 which controls the controllable subsystems 148 to perform the requested operation. Controlling the machine based on control inputs received from a remote operator over a secure remote control link is indicated by block 412 in FIG. 6.

This type of operation can involve authenticating remote operator 132, using operator authentication logic 138 on machine 106. For instance, because machine 106 is configured to be remotely controlled from a plurality of different remote operator computing systems 122-124 (which are not dedicated to only the requesting machine), machine 106 will illustratively authenticate any remote operator to ensure that the remote operator is authorized to control machine 106 to perform the requested operation. Thus, machine 106 may ensure that the remote operator 132 is authorized to perform operations on machine 106. Authenticating the operator on machine 106 is indicated by block 414.

Remote operator interaction logic 150 can also send machine data back to remote operator 132, as discussed above. This is indicated by block 416. It can decrypt the control signals that are sent using an encrypted communication protocol. This is indicated by block 418. It can provide the control signals to control system 146 which uses them to control the controllable subsystems 148. This is indicated by block 420. The machine can be controlled in other ways as well, based upon the inputs received from the remote operator 132. This is indicated by block 422.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

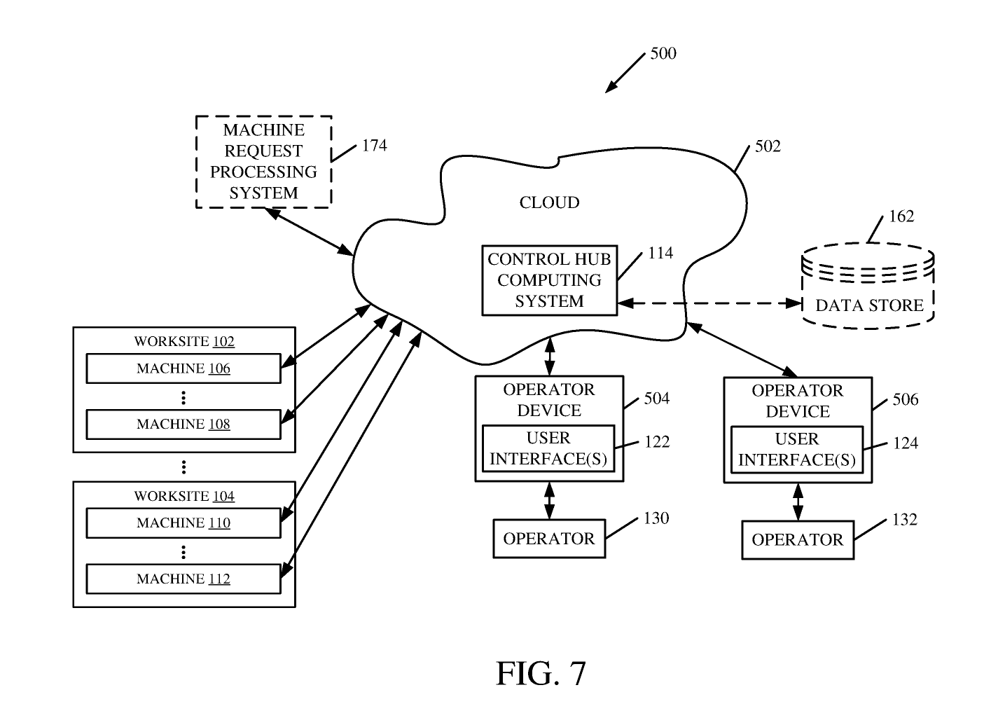

FIG. 7 is a block diagram of the architecture, shown in FIG. 1, except that it is deployed in a remote server architecture 500. In one example, remote server architecture 500 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown in FIG. 1 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided from a conventional server, or they can be installed on client devices directly, or in other ways.

In the example shown in FIG. 7, some items are similar to those shown in FIG. 1 and they are similarly numbered. FIG. 7 specifically shows that control hub computing system 114 can be located at a remote server location 502. Therefore, user devices 504-506, which have remote operator computing systems on them can access system 114 through remote server location 502.

FIG. 7 also depicts another example of a remote server architecture. FIG. 7 shows that it is also contemplated that some elements of FIG. 1 are disposed at remote server location 502 while others are not. By way of example, data store 162 and/or machine request processing system 174 (or other items) can be disposed at a location separate from location 502, and accessed through the remote server at location 502. Regardless of where they are located, they can be accessed directly by devices 504-506 and machines 106-112, through a network (either a wide area network or a local area network), they can be hosted at a remote site by a service, or they can be provided as a service, or accessed by a connection service that resides in a remote location. All of these architectures are contemplated herein.

It will also be noted that the elements of FIG. 1, or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

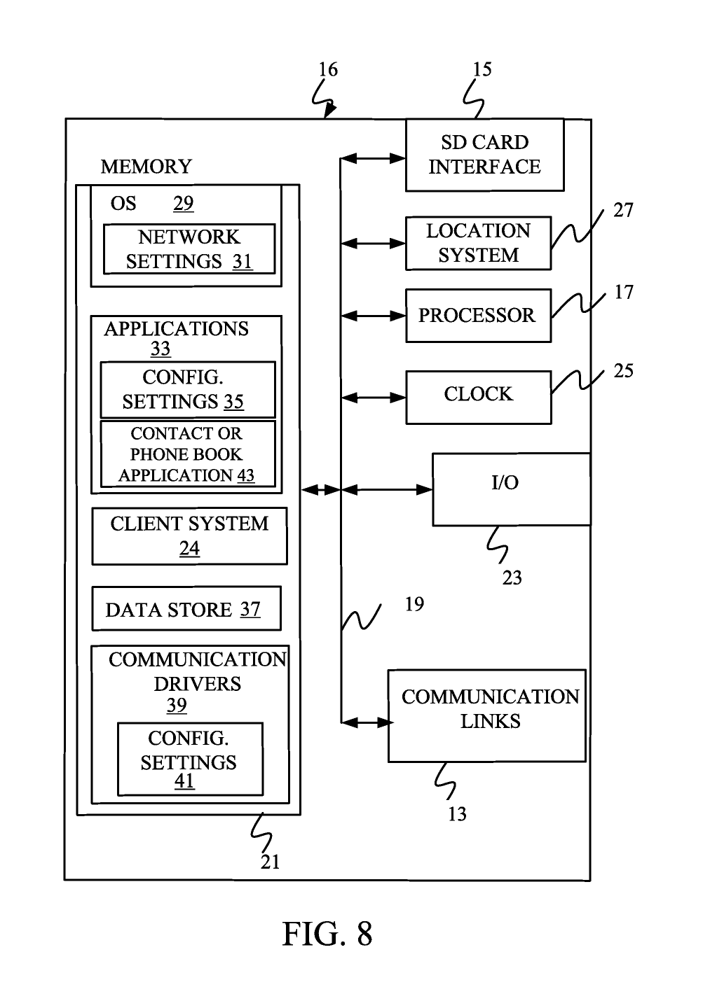

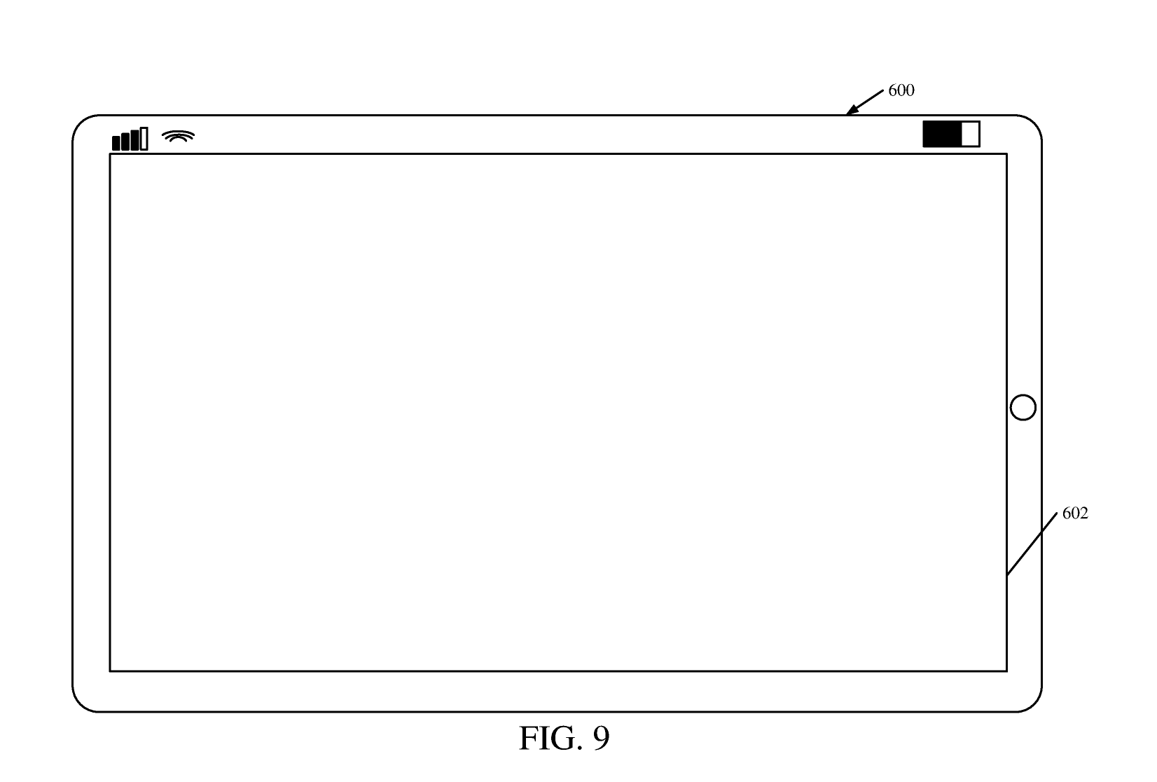

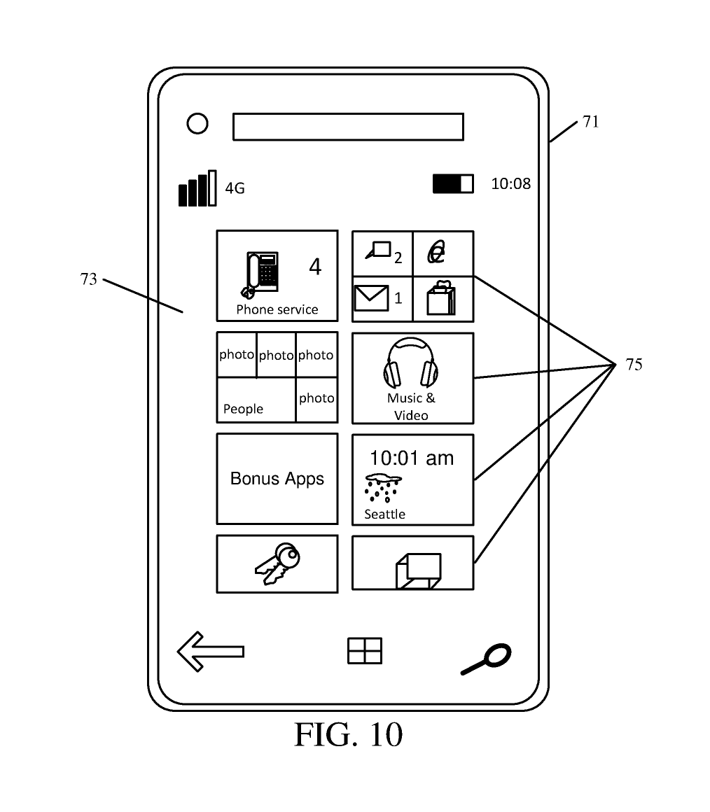

FIG. 8 is a simplified block diagram of one illustrative example of a handheld or mobile computing device that can be used as a user's or client's hand held device 16, in which the present system (or parts of it) can be deployed. For instance, a mobile device can be deployed as an operator device 504-506 for use in generating, processing, or displaying the information discussed above. It can be used by an operator at a worksite (such as by a truck operator to scan a QR Code) or otherwise. FIGS. 9-10 are examples of handheld or mobile devices.

FIG. 8 provides a general block diagram of the components of a client device 16 that can run some components shown in FIG. 1, that interacts with them, or both. In the device 16, a communications link 13 is provided that allows the handheld device to communicate with other computing devices and under some embodiments provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 9 shows one embodiment in which device 16 is a tablet computer 600. In FIG. 9, computer 600 is shown with user interface display screen 602. Screen 602 can be a touch screen or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 10 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

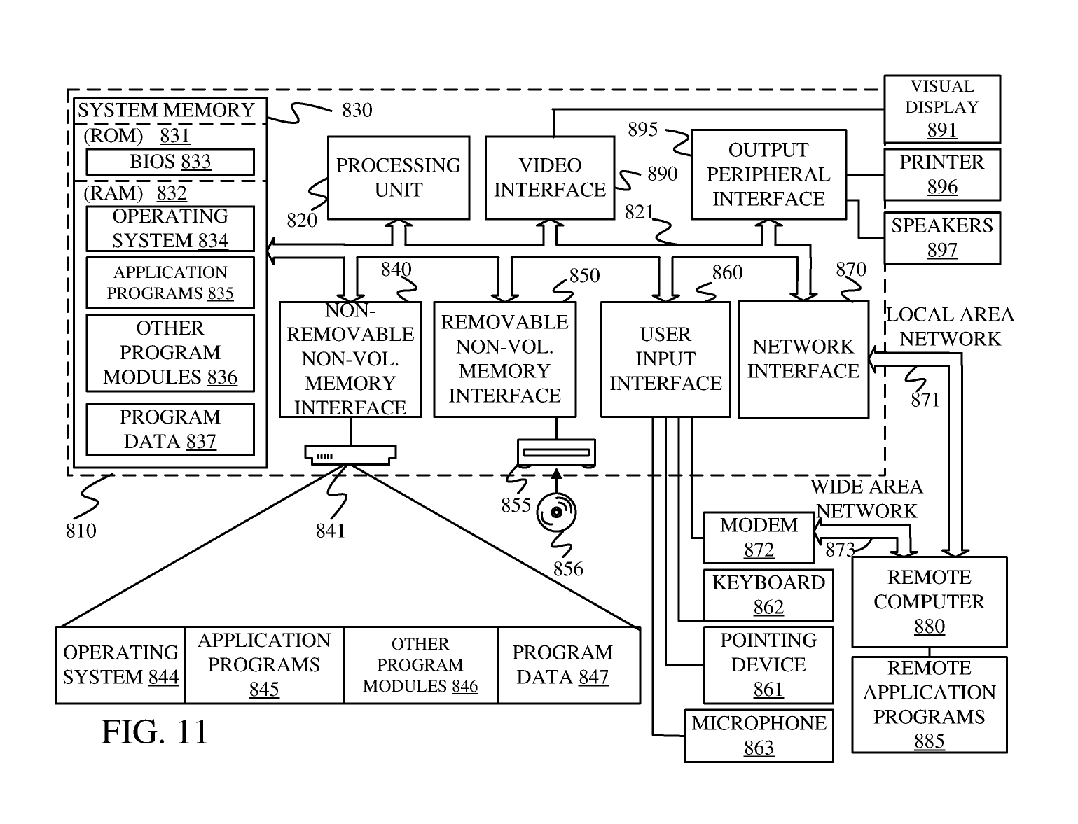

FIG. 11 is one example of a computing environment in which elements of FIG. 1, or parts of it, (for example) can be deployed. With reference to FIG. 11, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a local area network—LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 11 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Example 1 is a computing system, comprising:
a machine request detector that detects a first machine request, for remote controlled operation, from a first machine located remotely from the computing system and that detects a second machine request, for remote controlled operation, from a second machine located remotely from the computing system;
request parsing logic that identifies first machine information in the first machine request and second machine information in the second machine request;
operator selection logic that identifies a first remote operator at a first operator station remote from the computing system, to provide remote controlled operation of the first machine based on the first machine information, and that identifies a second remote operator at a second operator station remote from the computing system, to provide remote controlled operation of the second machine based on the second machine information; and
communication link control logic that facilitates remote machine control communication between the first operator station and the first machine and that facilitates remote machine control communication between the second operator station and the second machine.

Example 2 is the computing system of any or all previous examples wherein the request parsing logic is configured to identify a machine type corresponding to the first machine information indicating a type of the first machine, the operator selection logic being configured to access first operator information, identifying a machine type that the first operator is qualified to operate, and to identify the first operator to provide the remote controlled operation of the first machine based on the type of the first machine and the machine type that the first operator is qualified to operate.

Example 3 is the computing system of any or all previous examples wherein the request parsing logic is configured to identify an operation type corresponding to the first machine request indicating a type of requested operation of the first machine, the operator selection logic being configured to access the first operator information, identifying an operation type that the first operator is qualified to perform on the first machine, and to identify the first operator to provide the remote controlled operation of the first machine based on the type corresponding to the first machine and the operation type that the first operator is qualified to perform.

Example 4 is the computing system of any or all previous examples wherein the request parsing logic is configured to identify operator preference information based on the first machine information indicating an operator preference in operating the first machine, the operator selection logic being configured to access the first operator information, identifying an identity of the first operator, and to identify the first operator to provide the remote controlled operation of the first machine based on the operator preference information and the identity of the first operator.

Example 5 is the computing system of any or all previous examples wherein the request parsing logic is configured to identify a request urgency indicator based on the first machine request indicating an urgency of the first machine request, the operator selection logic being configured to access the first operator information, and to identify the first operator to provide the remote controlled operation of the first machine based on the first operator information and the request urgency indicator.

Example 6 is the computing system of any or all previous examples and further comprising:
an operator and machine tracking system configured to track a measure indicative of the first operator providing the remote controlled operation of the first machine and the second operator providing the remote controlled operation of the second machine.

Example 7 is the computing system of any or all previous examples wherein the communication link control logic is configured to provide encrypted control communication between the first operator station and the first machine and between the second operator station and the second machine.

Example 8 is a remote control computing system, comprising:
machine request detection logic that detects a machine request for remote controlled operation from a requesting machine;
machine type identification logic that identifies a machine type corresponding to the requesting machine based on the machine request;
mapping identification logic that identifies a set of user input-to-machine function mappings corresponding to the machine type of the requesting machine;
user input detection logic that detects operator control inputs; and
control data generation logic that generates control data, sent to the requesting machine to remotely control the requesting machine, based on the identified set of user input-to-machine function mappings and the detected operator control inputs.

Example 9 is the remote control computing system of any or all previous examples and further comprising:
a communication system configured to send the control data to the requesting machine using a security protocol.

Example 10 is the remote control computing system of any or all previous examples and further comprising:
a data store that stores a plurality of sets of user input-to-machine function mappings, each for a different machine type, the mapping identification logic being configured to access the data store to identify the set of user input-to-machine function mappings.

Example 11 is the remote control computing system of any or all previous examples and further comprising:
an operator authentication system configured to receive operator authentication information from an operator and authenticate the operator to use the remote control computing system based on the authentication information.

Example 12 is the remote control computing system of any or all previous examples and further comprising:
machine request acceptance logic configured to determine whether the authenticated operator is a qualified operator who is qualified to remotely control the requesting machine and to generate a request acceptance response to the requesting machine based on the authenticated operator being a qualified operator.

Example 13 is the remote control computing system of any or all previous examples and further comprising:
a user interface display; and
display control logic configured to receive operator interface data from the requesting machine and to control the user interface display to display the operator interface data as the operator performs the operator control inputs.

Example 14 is the remote control computing system of any or all previous examples wherein the display control logic is configured to display video data generated by a camera on the requesting machine and dashboard data generated by the requesting machine and being indicative of machine operating parameters corresponding to the requesting machine.

Example 15 is a computer implemented method, comprising:
detecting a machine request, for remote controlled operation, from a machine located at a remote worksite;
identifying operator filter criteria in the machine request;
filtering a plurality of different operators based on the operator filter criteria to identify a remote operator at an operator station remote from the first machine, to provide remote controlled operation of the machine; and
sending a request to the operator station to perform the remote controlled operation of the machine.

Example 16 is the computer implemented method of any or all previous examples and further comprising:
facilitating remote machine control communication between the operator station and the machine so the remote operator remotely controls the machine.

Example 17 is the computer implemented method of any or all previous examples wherein identifying operator filter criteria comprises identifying a machine type indicating a type of the machine, wherein filtering a plurality of operators comprises:
accessing operator information, identifying a machine type that the operator is qualified to operate; and
identifying the operator to provide the remote controlled operation of the first machine based on the type of the machine and the machine type that the operator is qualified to operate.

Example 18 is the computer implemented method of any or all previous examples wherein identifying operator filter criteria comprises identifying an operation type corresponding to the machine request, indicating a type of requested operation of the machine, and wherein filtering a plurality of operators comprises:
accessing the operator information, identifying an operation type that the operator is qualified to perform on the machine; and
identifying the operator to provide the remote controlled operation of the machine based on the type corresponding to the machine and the operation type that the operator is qualified to perform.

Example 19 is the computer implemented method of any or all previous examples and further comprising:
tracking a measure indicative of the operator providing the remote controlled operation of the machine.

Example 20 is the computer implemented method of any or all previous examples wherein facilitating remote machine control communication comprises:
providing encrypted control communication between the operator station and the machine.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a machine request detector that detects a first machine request, for remote controlled operation, from a first machine located remotely from the computing system and that detects a second machine request, for remote controlled operation, from a second machine located remotely from the computing system;
request parsing logic that identifies first machine information in the first machine request and second machine information in the second machine request;
operator selection logic that identifies a first remote operator at a first operator station remote from the computing system, to provide remote controlled operation of the first machine based on the first machine information, and that identifies a second remote operator at a second operator station remote from the computing system, to provide remote controlled operation of the second machine based on the second machine information; and
communication link control logic that facilitates remote machine control communication between the first operator station and the first machine and that facilitates remote machine control communication between the second operator station and the second machine.

2. The computing system of claim 1 wherein the request parsing logic is configured to identify a machine type corresponding to the first machine information indicating a type of the first machine, the operator selection logic being configured to access first operator information, identifying a machine type that the first operator is qualified to operate, and to identify the first operator to provide the remote controlled operation of the first machine based on the type of the first machine and the machine type that the first operator is qualified to operate.

3. The computing system of claim 2 wherein the request parsing logic is configured to identify an operation type corresponding to the first machine request indicating a type of requested operation of the first machine, the operator selection logic being configured to access the first operator information, identifying an operation type that the first operator is qualified to perform on the first machine, and to identify the first operator to provide the remote controlled operation of the first machine based on the type corresponding to the first machine and the operation type that the first operator is qualified to perform.

4. The computing system of claim 2 wherein the request parsing logic is configured to identify operator preference information based on the first machine information indicating an operator preference in operating the first machine, the operator selection logic being configured to access the first operator information, identifying an identity of the first operator, and to identify the first operator to provide the remote controlled operation of the first machine based on the operator preference information and the identity of the first operator.

5. The computing system of claim 2 wherein the request parsing logic is configured to identify a request urgency indicator based on the first machine request indicating an urgency of the first machine request, the operator selection logic being configured to access the first operator information, and to identify the first operator to provide the remote controlled operation of the first machine based on the first operator information and the request urgency indicator.

6. The computing system of claim 1 and further comprising:
an operator and machine tracking system configured to track a measure indicative of the first operator providing the remote controlled operation of the first machine and the second operator providing the remote controlled operation of the second machine.

7. The computing system of claim 1 wherein the communication link control logic is configured to provide encrypted control communication between the first operator station and the first machine and between the second operator station and the second machine.

8. A remote control computing system, comprising:
machine request detection logic that detects a machine request for remote controlled operation from a requesting machine;
machine type identification logic that identifies a machine type corresponding to the requesting machine based on the machine request;
mapping identification logic that identifies a set of user input-to-machine function mappings corresponding to the machine type of the requesting machine;
user input detection logic that detects operator control inputs; and
control data generation logic that generates control data, sent to the requesting machine to remotely control the requesting machine, based on the identified set of user input-to-machine function mappings and the detected operator control inputs.

9. The remote control computing system of claim 8 and further comprising:
a communication system configured to send the control data to the requesting machine using a security protocol.

10. The remote control computing system of claim 8 and further comprising:
a data store that stores a plurality of sets of user input-to-machine function mappings, each for a different machine type, the mapping identification logic being configured to access the data store to identify the set of user input-to-machine function mappings.

11. The remote control computing system of claim 10 and further comprising:
an operator authentication system configured to receive operator authentication information from an operator and authenticate the operator to use the remote control computing system based on the authentication information.

12. The remote control computing system of claim 11 and further comprising:
machine request acceptance logic configured to determine whether the authenticated operator is a qualified operator who is qualified to remotely control the requesting machine and to generate a request acceptance response to the requesting machine based on the authenticated operator being a qualified operator.

13. The remote control computing system of claim 8 and further comprising:
a user interface display; and
display control logic configured to receive operator interface data from the requesting machine and to control the user interface display to display the operator interface data as the operator performs the operator control inputs.

14. The remote control computing system of claim 13 wherein the display control logic is configured to display video data generated by a camera on the requesting machine and dashboard data generated by the requesting machine and being indicative of machine operating parameters corresponding to the requesting machine.

15. A computer implemented method, comprising:
detecting a machine request, for remote controlled operation, from a machine located at a remote worksite;
identifying operator filter criteria in the machine request;
filtering a plurality of different operators based on the operator filter criteria to identify a remote operator at an operator station remote from the first machine, to provide remote controlled operation of the machine; and
sending a request to the operator station to perform the remote controlled operation of the machine.

16. The computer implemented method of claim 15 and further comprising:
facilitating remote machine control communication between the operator station and the machine so the remote operator remotely controls the machine.

17. The computer implemented method of claim 16 wherein identifying operator filter criteria comprises identifying a machine type indicating a type of the machine, wherein filtering a plurality of operators comprises:
accessing operator information, identifying a machine type that the operator is qualified to operate; and
identifying the operator to provide the remote controlled operation of the first machine based on the type of the machine and the machine type that the operator is qualified to operate.

18. The computer implemented method of claim 17 wherein identifying operator filter criteria comprises identifying an operation type corresponding to the machine request, indicating a type of requested operation of the machine, and wherein filtering a plurality of operators comprises:
accessing the operator information, identifying an operation type that the operator is qualified to perform on the machine; and
identifying the operator to provide the remote controlled operation of the machine based on the type corresponding to the machine and the operation type that the operator is qualified to perform.

19. The computer implemented method of claim 15 and further comprising:
tracking a measure indicative of the operator providing the remote controlled operation of the machine.

20. The computer implemented method of claim 16 wherein facilitating remote machine control communication comprises:
providing encrypted control communication between the operator station and the machine.
